(19) United States
(12) Patent Application Publication
(10) Pub. No.: US 2007/0120291 A1
(43) Pub. Date: May 31, 2007

(54) Method for forming lugs of micro-SD

(76) Inventors: Hsieh Chih Hung, Hsinchu City (TW); Hiew Siew Sin, San Jose, CA (US)

Correspondence Address: ROSENBERG, KLEIN & LEE, 3458 ELLICOTT CENTER DRIVE-SUITE 101, ELLICOTT CITY, MD, 21043, US

(21) Appl. No.: 11/287,267

(22) Filed: Nov. 28, 2005

(51) Int. Cl. B29C 45/14

(52) U.S. Cl. 264/272.14; 264/272.15; 264/157

(57) ABSTRACT

A method for forming lugs of microSD ( Secure Digital ) including steps of: preparing a mold previously formed with multiple mold cavities, each mold cavity having a profile corresponding to a profile of a final glue-sealed microSD product with a lug; tightly closing the mold to hold the microSD units in the mold cavities; filling up glue material into the mold cavities; hardening the glue material in the mold cavities; opening the mold to take out the connecting board with the glue-sealed products; and cutting the connecting sections between the glue-sealed microSD products of the connecting board to achieve multiple microSD products.

### BACKGROUND OF THE INVENTION

The present invention is related to a method for forming lugs of microSD (Secure Digital) . A mold previously formed with multiple mold cavities is prepared. Each mold cavity has a profile corresponding to a profile of a final glue-sealed microSD product with a lug. Therefore, when the microSD units received in the mold cavities are sealed with the glue material, the microSD units are molded into multiple glue-sealed microSD products with the lugs.

The existent microSD card is portable and compatible with SD card and miniSD. The microSD is specifically designed for wireless telecommunication market. The current cellular phones have inbuilt high-resolution camera function, data download function, compatibility with PC and other more complicated application functions. Therefore, a great amount of microSD is required on the market.

The lug of the conventional microSD is formed in such a manner that a common gluing packaging measure is used to seal the whole microSD connecting board 6 accomplished in the preceding manufacturing procedure as shown in FIG. 6. Then a water knife or a laser cutter 7 is used to cut the microSD connecting board 6 along the specification profile 61 of the microSD into multiple microSD units 62 with lugs. The microSD connecting board 6 can be glued and packaged at one time. However, the requirement for the specification profiles 61 of the lugs of the microSD is quite strict. Therefore, it is time-consuming to cut the microSD connecting board 6 and it is hard to mass-produce the microSD units.

It is therefore tried by the applicant to provide an improved manufacturing method for the lugs of the microSD so as to enhance the manufacturing efficiency.

### SUMMARY OF THE INVENTION

It is therefore a primary object of the present invention to provide a method for forming lugs of microSD. A mold previously formed with multiple mold cavities is prepared. Each mold cavity has a profile corresponding to a profile of a final glue-sealed microSD product with a lug. Therefore, when the microSD units of the connecting board received in the mold cavities are sealed with the glue material, the microSD units are molded into multiple glue-sealed microSD products with the lugs. Therefore, the cutting time is saved and the manufacturing efficiency is enhanced.

According to the above objects, method for forming lugs of microSD of the present invention includes steps of:

preparing at least one connecting board on which an array of microSD units are arranged, the microSD units being interconnected and connected with the connecting board by connecting sections;

preparing a mold formed with multiple mold cavities in each of which a microSD unit is receivable, each mold cavity having a profile corresponding to a profile of a final glue-sealed microSD product with a lug;

tightly closing the mold to hold the microSD units in the mold cavities;

filling glue material into the mold cavities;

hardening the glue material in the mold cavities;

opening the mold to take out the connecting board with the glue-sealed products; and

cutting the connecting sections between the glue-sealed microSD products of the connecting board to achieve multiple microSD products.

The present invention can be best understood through the following description and accompanying drawings wherein:

### BRIEF DESCRIPTION OF THE DRAWINGS

FIG. 1 is a perspective view of the connecting board used in the method of the present invention, on which an array of microSD units are arranged;

FIG. 2 is a sectional view showing that the mold of the present invention in an opened state before glue-sealing step;

FIG. 3 is a sectional view showing that the mold of the present invention is closed and the microSD units are glue-sealing;

FIG. 4 is a plane view showing that the glue-sealed microSD units are cut into the products;

FIG. 5A is a top view of the glue-sealed microSD product of the present invention;

FIG. 5B is a bottom view of the glue-sealed microSD product of the present invention; and

FIG. 6 shows that a conventional method for manufacturing glue-sealed microSD products with lugs, in which a laser cutter is, used to cut the microSD connecting board along the specification profile of the microSD.

### DETAILED DESCRIPTION OF THE PREFERRED EMBODIMENT

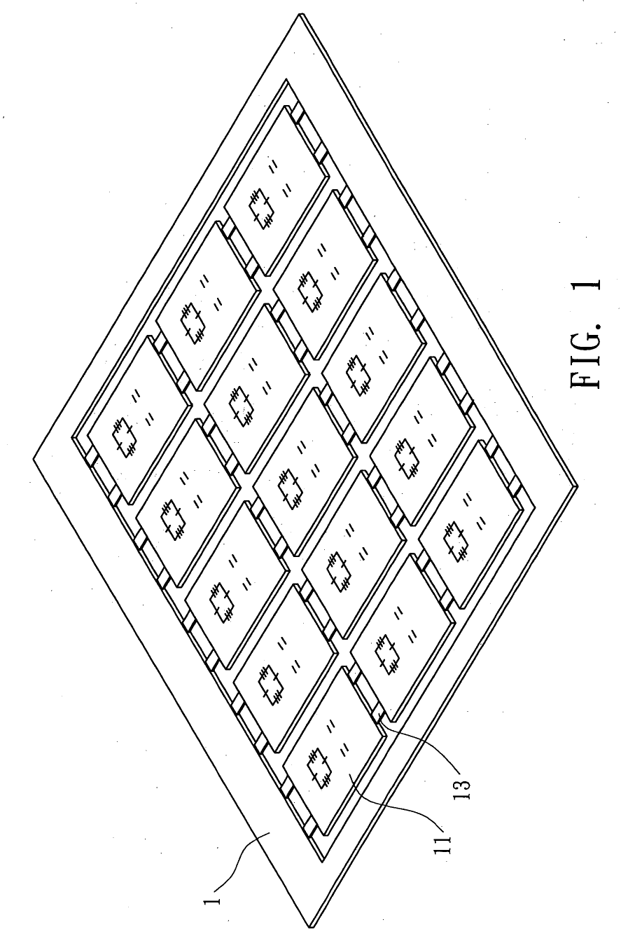

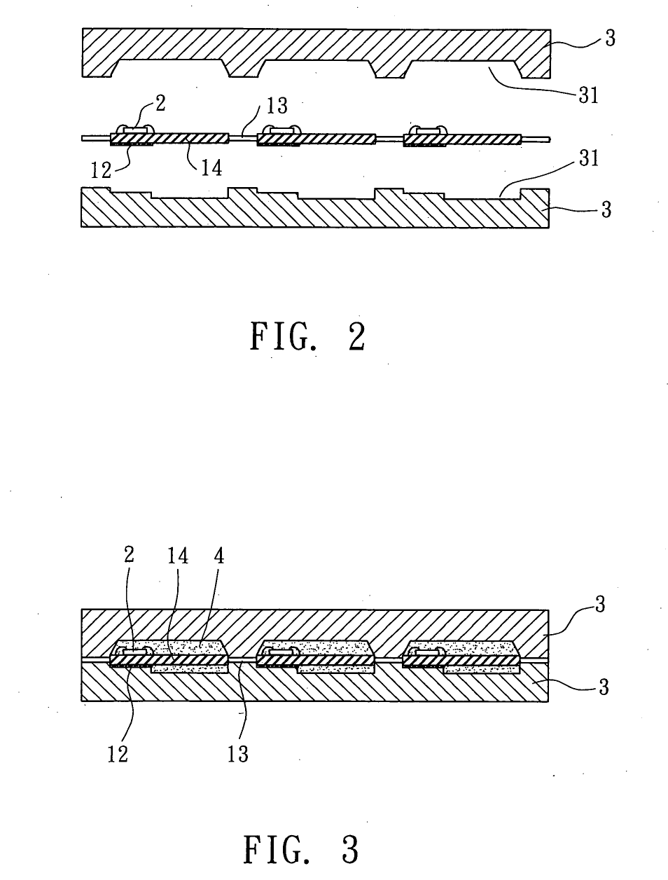

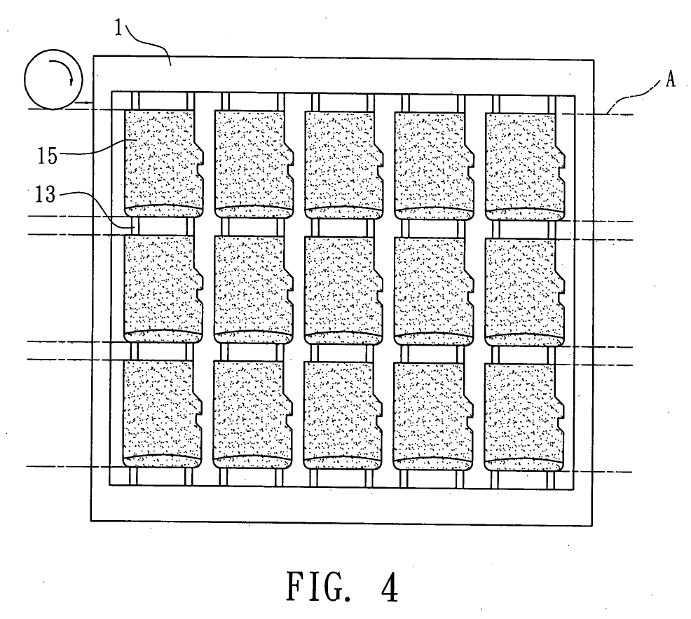

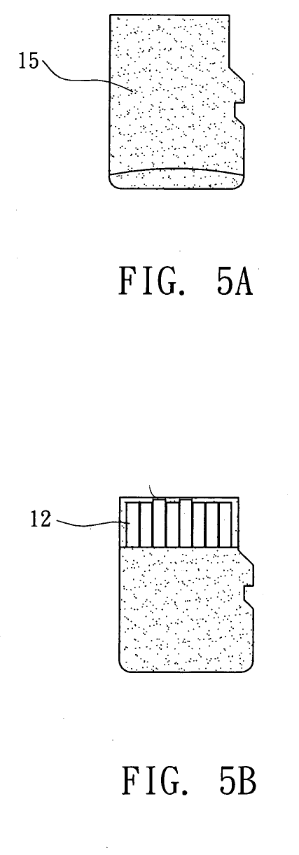

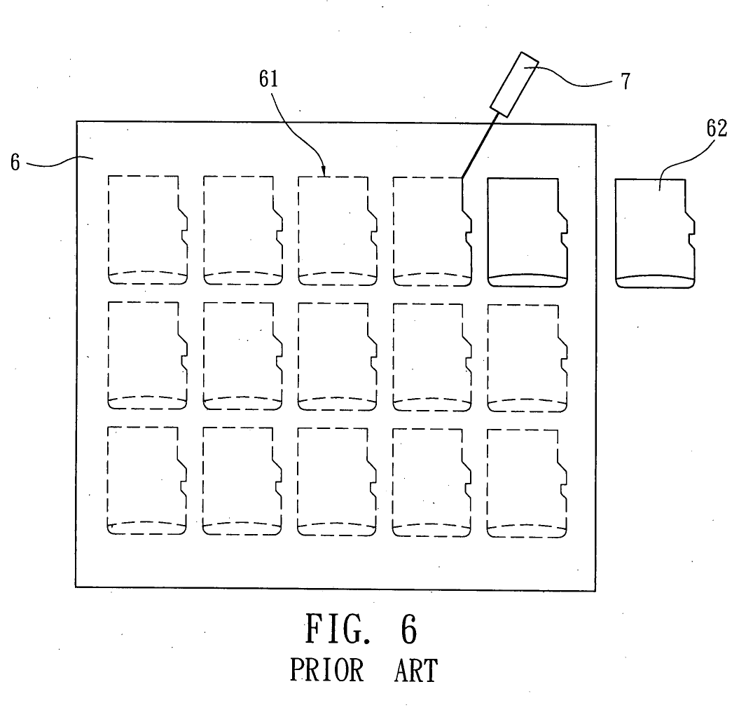

Please refer to FIGS. 1 to 5. The method for forming the lugs of microSD (Secure Digital) of the present invention includes steps of:
(a) preparing at least one connecting board 1 on which an array of microSD units 11 are arranged, each microSD unit 11 having an electric contact 12 on back face for contacting with outer side, the microSD units 11 being interconnected and connected with the connecting board 1 by connecting sections 13;
(b) mounting several memory card chips 2 on the memory card substrates 14 of the connecting board 1 by means of common soldering procedure;
(c) preparing a mold 3 formed with multiple mold cavities 31 in each of which a microSD unit 11 is receivable, each mold cavity 31 having a profile corresponding to a profile of a final glue-sealed microSD product 15 with a lug;
(d) tightly closing the mold 3 to hold the microSD units 11 in the mold cavities 31;
(e) filling up glue material 4 into the mold cavities 31 to seal the microSD units 11 and achieve a microSD glue body 15 with a predetermined thickness and a profile with a lug;
(f) waiting for a period of time until the glue material 4 in the mold cavities 31 hardens;
(g) opening the mold 3 to take out the connecting board 1 with the glue-sealed products; and
(h) along a phantom cutting line A planned with a cutting equipment cutting the connecting sections 13 between the glue-sealed microSD products 15 of the connecting board 1 to achieve multiple microSD products.

The mold 3 is previously formed with the mold cavities 31 having the profile of the lug. Therefore, after glue-sealed, the microSD units 11 of the connecting board 1 can be directly molded into glue-sealed microSD products 15 with the lugs. Accordingly, it is no more necessary to use the expensive water knife or laser cutter for cutting the products 15 according to the specification and size of the profile of the glue body. Instead, it is only necessary to cut off the connecting sections 13 between the glue-sealed microSD products 15. Therefore, the microSD products can be mass-produced to save time and enhance the manufacturing efficiency.

The above embodiment is only used to illustrate the present invention, not intended to limit the scope thereof. Many modifications of the above embodiment can be made without departing from the spirit of the present invention.

What is claimed is:

1. A method for forming lugs of microSD (Secure Digital), comprising steps of:
preparing at least one connecting board on which an array of microSD units are arranged, the microSD units being interconnected and connected with the connecting board by connecting sections;
preparing a mold formed with multiple mold cavities in each of which a microSD unit is receivable, each mold cavity having a profile corresponding to a profile of a final glue-sealed microSD product with a lug;
tightly closing the mold to hold the microSD units in the mold cavities;
filling glue material into the mold cavities;
hardening the glue material in the mold cavities;
opening the mold to take out the connecting board with the glue-sealed products; and
cutting the connecting sections between the glue-sealed microSD products of the connecting board to achieve multiple microSD products.
